(19) United States
(12) Patent Application Publication
(10) Pub. No.: US 2001/0032486 A1
(43) Pub. Date: Oct. 25, 2001

(54) Pneumatic lock operator for roll-up doors for truck trailers

(76) Inventor: Richard L. Doucette, Williamston, MI (US)

Correspondence Address: Waters & Morse, P.C., 400 Ledyard Building, 125 Ottawa, Avenue, NW, Grand Rapids, MI, 49503, US

(21) Appl. No.: 09/810,779

(22) Filed: Mar. 16, 2001

Related U.S. Application Data
(60) Provisional application No. 60/190,290, filed on Mar. 17, 2000.

(51) Int. Cl. E05B 15/00

(52) U.S. Cl. 70/266

(57) ABSTRACT

A lock operator for operating locking rods in a roll-up door locking mechanism in a truck or trailer comprises a pneumatic drive cylinder for each locking rod that reciprocates the locking rod between its locked and unlocked positions. A button-operated actuator valve located at the front of the truck trailer connects the truck pressurized air system to all of the drive cylinders to lock the locking rods at all four comers of the trailer simultaneously. A spring or double acting cylinder return mechanism unlocks the locking mechanism when the air pressure is relieved. The pneumatic operators are mounted on mounting plates between the inside and outside skins of the trailer and are accessible through removable inspection plates on the inside of the trailer. Each drive cylinder is linked to a locking bar by a vertically reciprocable yoke mechanism.

### CROSS-REFERENCES TO RELATED APPLICATIONS

This is a continuing non-provisional application based on and claiming the filing priority of co-pending provisional patent application Ser. No. 60/190,290, filed Mar. 17, 2000.

### STATEMENT REGARDING FEDERALLY SPONSORED RESEARCH OR DEVELOPMENT

Not Applicable.

### BACKGROUND OF THE INVENTION

In many conventional trucks and truck trailers having roll-up doors, the doors are locked and unlocked by overhead lock mechanisms located adjacent the four comers of the trailer. The lock mechanisms typically are activated by mechanical handles located adjacent a lower portion of each door. These mechanical handles operate vertical locking rods that are moved downwardly in order to actuate the locking mechanisms. Locking and unlocking doors in this manner with a mechanical handle is time consuming, and mechanical handles and replacement parts therefor are expensive.

An object of the present invention is to provide a simple, pneumatic operator wherein all of the roll-up door locking mechanisms may be actuated at one time by means of a conveniently located, key-actuated button located on each side of the front of the trailer.

### BRIEF SUMMARY OF THE INVENTION

In accordance with the present invention, a lock operator for operating a roll-up door locking mechanism in a truck or trailer comprises a pneumatic drive cylinder for each locking rod that reciprocates the locking rod between its locked and unlocked positions. The drive cylinder is actuated by a button-operated actuator valve located conveniently at the front of the truck trailer. The actuator valve connects the truck pressurized air system with the pneumatic drive cylinders. Depression of the actuating button transmits pressurized air to all of the drive cylinders and actuates the drive cylinders to lock the locking rods at all four comers of the trailer simultaneously. The button can be locked in an actuated (locked) position and thereafter can be unlocked with a key in order to relieve air pressure to the air cylinders and unlock the doors. In one embodiment, a spring return mechanism unlocks the locking mechanism when the air pressure is relieved. A double acting cylinder can be used instead of the spring return spring in order to provide pneumatic lock opening and closing.

The pneumatic operators are mounted on mounting plates that are mounted on the inside surface of the outside skin of a trailer, between the inside and outside skins. The actuator mechanism is accessible through a removable inspection plate on the inside of the trailer. Each drive cylinder is connected to a locking bar by a link mechanism in the form of a yoke that is vertically reciprocable in the mechanism.

The present invention comprises a simple concealed operating mechanism that makes it possible to operate four locking mechanisms at the comers of a trailer simultaneously by the depression of a single button at the front end of either or both sides of the trailer.

These and other features of the present invention will here and after appear and for purposes of illustration but not of limitation, a preferred embodiment of the invention is described in detail below and shown in the appended drawings.

### BRIEF DESCRIPTION OF THE DRAWINGS

FIG. 1 is a perspective view of a truck and trailer employing the lock operator of the present invention.

FIG. 2 is a fragmentary perspective view showing one unit of the lock operator of the present invention mounted between inside and outside skins of a trailer.

FIG. 3 is a front elevational view of one unit of the present invention, taken from the inside of the truck.

FIG. 4 is a fragmentary perspective view of an actuator button and valve of the present invention.

FIG. 5 is a schematic view of one embodiment of a lock operator employing a single-action drive cylinder with a spring return.

FIG. 6 is a schematic view of a second embodiment of a lock operator employing a double-acting drive cylinder, with a pneumatic return stroke as well as a pneumatic drive stroke.

FIG. 7 is a perspective view of a rear corner of a truck trailer showing the present invention, employing an actuator button.

FIG. 8 is a sectional view taken along lines 8-8 of FIG. 7.

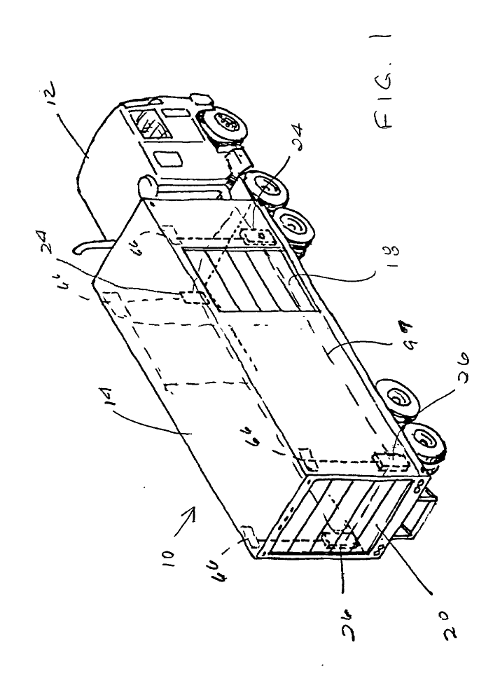

### DETAILED DESCRIPTION OF PREFERRED EMBODIMENTS

The present invention also can be used on a truck storage compartment or on the trailer of a semi-trailer. For exemplary purposes, a semi-trailer installation is shown. Reference to a trailer herein is intended to include a truck storage compartment.

Referring to the drawings, a truck 10 comprises a cab 12 and a trailer 14. The truck includes a pressurized air system 16 for operation of air brakes and the like. This air system is also used to power the pneumatic lock operator of the present invention.

The trailer 14 of the present invention includes conventional roll-up doors 18 and 20, which may be located at the sides or rear of the truck or both . These doors are locked in their downward positions by conventional locking mechanisms 66 that are actuated by conventional locking rods 64. In a typical trailer, the locking rods are actuated or locked by moving the locking rods in a downward position from an unlocked position to a locked position. Conversely, the locks are unlocked by moving the locking rods upwardly to their unlocked positions. In a conventional truck trailer, each locking rod is reciprocated upwardly and downwardly by a handle or lever.

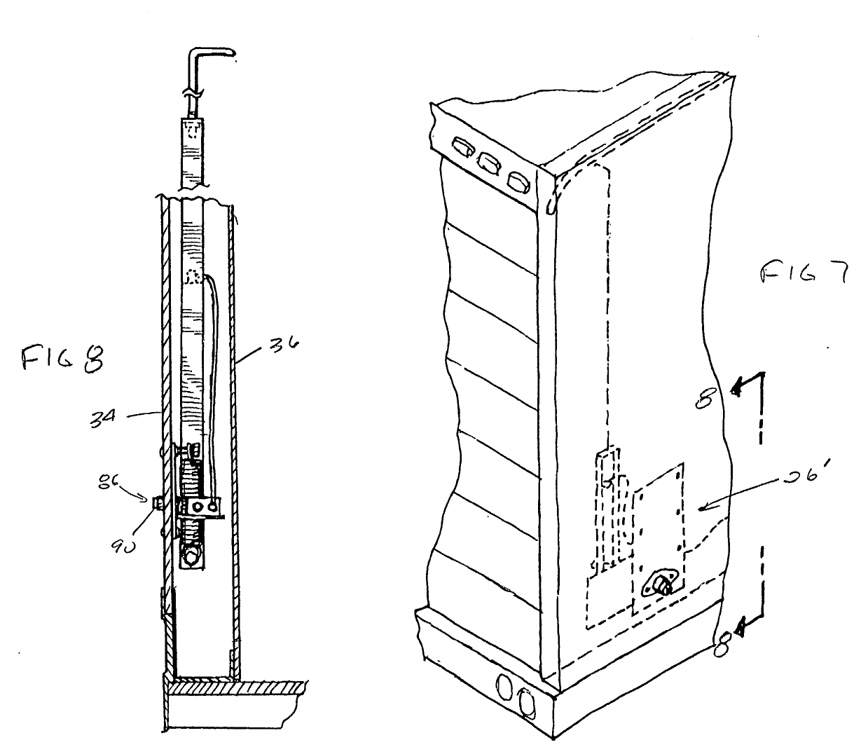

In the present invention, mechanical handles are replaced with four pneumatic lock operators, two lock operators 24 being positioned at opposite sides of the front of the trailer, and two lock operators 26 being positioned at opposite sides of the rear of the trailer. The front and rear actuators are the same, with the exception that the front operators include a button to actuate the lock units, whereas the rear locking units are generally slave-driven by the locking units at the front and do not include their own actuator buttons. The rear locking units could also have button actuators, if desired, as illustrated by operators 26′ of FIG. 7.

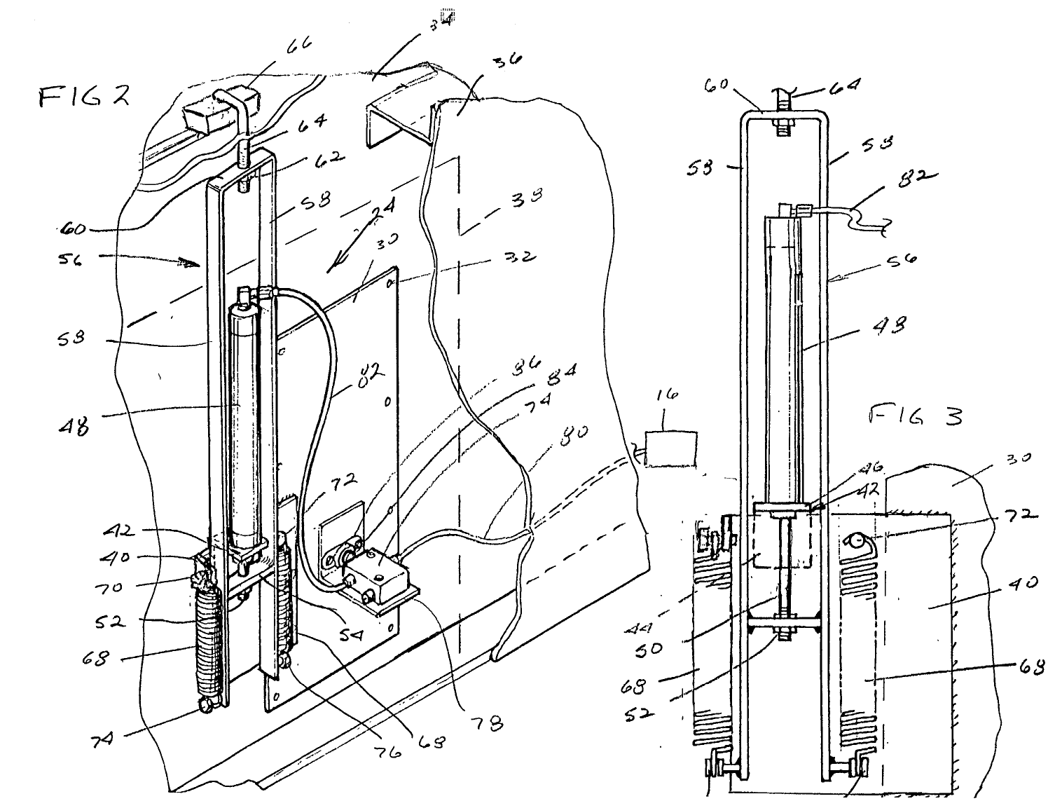

Referring to FIG. 2, lock operator 24 includes a face plate 30 that is attached by rivets or bolts 32 to the outer skin 34 of a trailer between outer skin 34 and inner skin 36. An access plate 38 (shown in phantom) is removed from the inner skin in order to provide access for mounting, dismounting, and servicing the lock operator.

A cylinder mounting plate 40 is welded on a lower side of face plate 30 and extends laterally to the side. A right angle cylinder mounting bracket 42 having a downwardly extending leg 44 and a generally horizontal leg 46 is welded to the top of the cylinder mounting plate, such that the horizontal plate extends inwardly toward the inside of the trailer. A pneumatic drive cylinder or air cylinder 48 is mounted vertically on the top of cylinder mounting bracket 42 and has a downwardly extending output or drive shaft 50 that extends through an opening in horizontal leg 46 to a lower end 52. The lower end of the cylinder output shaft is attached to a cross member 54 of a link or yoke 56. The yoke 56 is a downwardly facing U-shaped member having parallel, vertical legs 58 and a top cross bar 60. The cross bar 60 has a central threaded hole 62 therein. Locking rod 64 of a conventional roll-up top locking mechanism is threaded into opening 62 in the yoke and extends upwardly into operative connection with a conventional locking mechanism 66.

A pair of coil extension springs 68 is attached between studs 70 and 72 mounted to cylinder mounting plate 40 and studs 74 and 76 on the lower ends of the yoke. The coil springs urge the yoke toward its upward or unlocked position.

Air cylinder 48 is actuated by the vehicle air system 16 through an actuating valve 74. Actuating valve 74 is mounted on face plate 30 by means of an L-shaped bracket 76, with the actuating valve being mounted on a horizontal plate 78 of the angle bracket. The valve 74 has an inlet 80 attached to the vehicle pressurized air system. An outlet conduit 82 extends from the valve to the air cylinder. A valve actuating button 84 extends out of an end of the valve and faces a push button lock actuator 86 on the exterior of the face plate. When a button 90 on lock actuator 86 on the exterior of the face plate is depressed, this depresses the valve actuator button 84 and moves the valve from a deactuated position to an actuated position. When the valve is deactuated, air flow through the valve is blocked. When the valve is actuated, pressurized air flows through the valve into the air cylinder, causing the air cylinder to extend downwardly, which in turn engages the yoke and causes the locking mechanism to become engaged or actuated.

The valve 74 of the present invention can be single-acting valve, biased to its closed position. A double-acting valve also could be employed (as shown in FIG. 6).

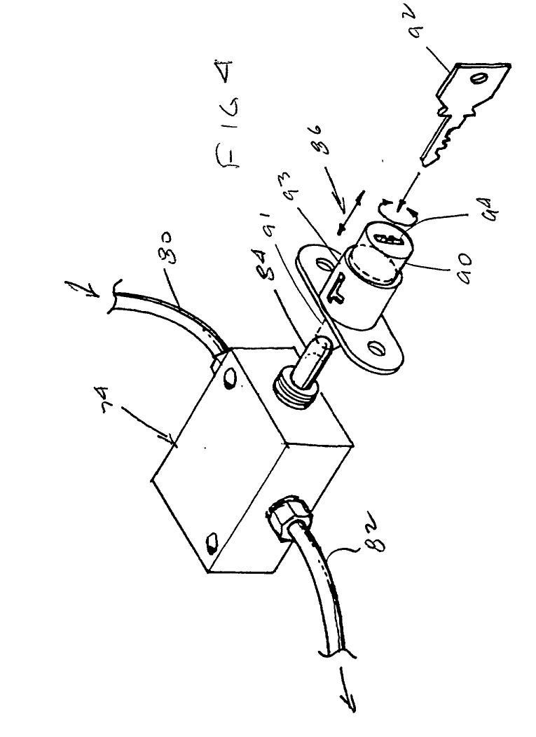

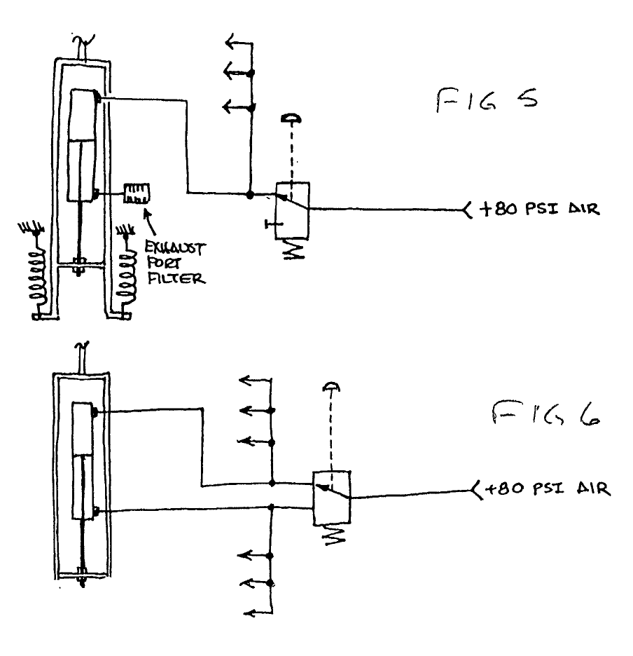

Referring to FIG. 8, the push button 90 of the push button actuator 86 extends through the outer skin 34 of the trailer, and can be depressed by the operator. When the button is depressed, an internal portion 91 of the button (FIG. 4) depresses the valve actuator button 84 on the valve and causes the valve to move to its actuated position. The button 90 is held in its depressed condition after being depressed by latch 93. A key 92 can be inserted in a slot 94 in the button and turned in order to release the latch and permit the button to return under spring pressure to its deactuated position, wherein pressure is released and the locking mechanism is also released.

All four locking mechanisms at the four corners of the trailer are connected together by conduit 97, so that the depression of one actuating button causes all four locking mechanisms to be actuated simultaneously and released simultaneously. Thus, a single button can be used to lock all four locking mechanisms at once. While the rear operators generally are slave driven, they can, if desired, be provided with push button actuators 86′, as shown in FIG. 7.

It should be recognized that the foregoing is merely representative of a preferred embodiment of the present invention and that various changes and modifications may be made in the arrangements and details of construction of the embodiments disclosed herein without departing from the spirit and scope of the present invention, as defined in the appended claims.

I claim:

1. A lock operator that operates an access door lock assembly in a truck or truck trailer between locked and unlocked conditions by sliding a locking rod between corresponding actuated and deactuated positions, respectively, the lock operator comprising:
a drive cylinder that is operatively connected with each locking rod and that slides the locking rod from its deactuated to its actuated position when the drive cylinder is actuated;
deactuation means operatively connected with the locking rod for urging the locking rod to its deactuated position when the drive cylinder is deactuated; and
a manually operable actuator that selectively actuates the drive cylinder.

2. The lock operator of claim 1 wherein the cylinder is one of a group of cylinders consisting of hydraulic, pneumatic, and electrically operated cylinders.

3. The lock operator of claim 2 wherein the cylinder is a pneumatic drive cylinder.

4. The lock operator of claim 3 wherein the track or trailer has a plurality of lock assemblies positioned at spaced locations, with each lock assembly being operated by its own locking bar, the lock operator including a separate pneumatic operator for each locking rod, with the operators being interconnected such that all operators can be actuated simultaneously by a single actuator.
